(19) United States
(12) Patent Application Publication
(10) Pub. No.: US 2016/0167446 A1
(43) Pub. Date: Jun. 16, 2016

(54) TIRE SERVICE LIFE MONITORING

(71) Applicant: The Goodyear Tire & Rubber Company, Akron, OH (US)

(72) Inventors: Su Xu, Akron, OH (US); Madhu Sudhana Kirugulige Rao, Bridel (LU)

(21) Appl. No.: 14/566,324

(22) Filed: Dec. 10, 2014

(51) Int. Cl. B60C 11/24; G06F 17/30

(52) U.S. Cl. CPC B60C 11/246; G06F 17/30342; G06F 17/30368

(57) ABSTRACT

A method, apparatus and program product to monitor tire service life for one or more vehicles based at least in part on collected tire data. Received tire data for a tire may be analyzed to determine whether a service life of the tire corresponds to an end of service life of a tire data model. Responsive to determining that the service life of the tire corresponds to the end of service life of the tire data model, an alarm may be generated for the tire.

### FIELD OF THE INVENTION

The invention relates generally to tire monitoring and warning systems.

### BACKGROUND OF THE INVENTION

It is well documented that maintaining a correct tire pressure can improve handling, increases gas mileage, and extends the useful life of vehicle tires. Moreover, while such factors are important to the owners of individual passenger vehicles, for fleets of commercial vehicles such as tractor trailers, trucks, buses, vans, and other types of commercial vehicles, such factors may have a significant effect on profitability, both in terms of energy consumption costs and tire replacement and/or retread costs.

Despite its irrefutable importance, tire pressure may not be monitored and maintained frequently enough by many fleets, as well as many in the overall driving public. In addition, with the advent of “extended mobility tires” (EMT) and their increasingly widespread commercial presence, it may be difficult for a vehicle operator to detect a low pressure or leak condition and take appropriate action. As a result, extended use of a tire in a low pressure condition beyond the manufacturer's recommended limit may occur.

Various legislative approaches requiring the communication of tire pressure information to the operator of a vehicle have been proposed, including a mandate that new vehicles be equipped with a low tire pressure monitoring system. Conventional tire pressure monitoring systems (TPMS's) typically incorporate a sensor located on each tire in a vehicle to perform real-time interior air pressure and temperature monitoring. The information is wirelessly transmitted to the driver via radio band frequencies (RF) and displayed in the driver compartment of the vehicle. The remote sensing module typically includes a pressure sensor, a temperature sensor, a signal processor, and an RF transmitter, and may be powered by a battery. Alternatively, a sensing module may be “passive”; that is, power may be supplied to the sensing module by way of magnetic coupling with a remote transmitter. The receiver may either be dedicated to tire pressure monitoring or share other functions in the vehicle. For instance the receiver controller may be the existing dashboard controller or the body controller. The receiver itself may further be shared with other systems using the same frequency range such as a remote keyless entry system.

The purpose of a tire monitoring system is to provide the driver with a warning should an anomaly occur in one or more tires. In some instances, tire pressure and/or temperature may be reported and/or displayed, while in other instances a simple low pressure alert may be generated. To be useful, the information must be quickly communicated and be reliable. However, displaying data derived from raw sensor measurements of temperature and pressure is not always sufficient to accurately represent the status of a tire at any given time and at various loads and conditions. The interpretation of measured data relating to temperature and pressure, therefore, is important, but has heretofore been problematic. Temperature and pressure readings by sensors in communication with a tire under conditions of actual use are influenced by various factors including heat emitted by the brakes; the thermal dissipation from the tire to the rim; load transfers that cause slight variations of the volume of the tires; and heat build-up in the tire due to its hysteretic losses. Such factors can affect the accuracy of information communicated to the driver, failing to alert the driver of marginal tire conditions under some circumstances and issuing false alarms to the driver in other instances.

Timeliness is also a concern with respect to conventional tire monitoring systems. Alerts to a driver of a low tire pressure condition may be based on simple thresholds, and once the driver is alerted due to the pressure falling below a threshold, the tire has already reached a non-optimal state. Leakages in a tire may be slow or fast, and particularly for faster leaks, the alert to the driver may be too late to enable the driver to rectify the situation without encountering a tire disablement, having to immediately stop the vehicle and change the tire or call for roadside assistance.

Consequently, a need exists in the art for processing information in a tire pressure monitoring system in an accurate and timely manner.

Furthermore, with respect to commercial vehicles, oftentimes the vehicles have more tires, travel greater distances, and thus a greater likelihood of encountering tire-related issues, as well as typically a greater difficulty in resolving tire-related issues while in transit. For over-the-road tractor trailers, for example, the nearest service center may be tens of miles away and in many cases, a service vehicle will need to be dispatched to provide roadside assistance. In addition, from the perspective of a fleet, coordinating the service and maintenance of multiple fleet vehicles compounds these risks.

Therefore, a need also exists in the art for a tire monitoring system capable of reducing vehicle downtime, improving fuel economy, and reducing tire costs associated with fleets and the commercial vehicles used thereby.

### SUMMARY OF THE INVENTION

The invention addresses these and other problems associated with the prior art by providing a method, apparatus and program product that monitors useful service life for one or more tires of a vehicle. In general, useful service life, or just service life corresponds to a usage period that a tire may be expected to function normally for its intended purpose, and beyond which replacement of the tire may be advisable. Consistent with embodiments of the invention, tire data is received for a particular tire of a vehicle. The tire data is analyzed with a tire data model to determine whether a service life of the particular tire corresponds to an end of service life of the tire data model. In response to determining that the service life of the particular tire corresponds to an end of service life of the tire data model, an alarm is generated for the particular tire.

Consistent with some embodiments of the invention, an end of service life of the tire data model corresponds to a period of usage at which, according to the model, precedes a potential tire disablement that renders the tire unusable. For example, an end of service life of the tire data model may be utilized to determine whether a particular tire for which tire data is analyzed with the model is within 100 miles of a potential tire disablement. In general, the tire data model and the end of service life of the tire data model may be based at least in part on tire data collected from one or more tires of one or more vehicles, including for example, a vehicle for which a tire is being monitored.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a tire health monitoring system consistent with the invention.

FIG. 2 is a block diagram illustrating the flow of data between components in the tire health monitoring system of FIG. 1.

FIG. 3 is a block diagram of an exemplary hardware and software environment suitable for implementing the tire health monitoring system of FIG. 1.

FIG. 4 is a block diagram that provides an example tire layout for an example vehicle that may be monitored by the hardware and software environment of FIG. 3.

FIG. 5 is a flowchart that illustrates a sequence of operations that may be performed by the hardware and software environment of FIG. 3 to monitor a service life of a tire to detect when the tire is in an end of service life condition.

FIG. 6 is a flowchart that illustrates a sequence of operations that may be performed by the hardware and software environment of FIG. 3 to evaluate tire data of a tire with a tire data model when monitoring a service life of the tire consistent with embodiments of the invention.

FIG. 7 is a flowchart that illustrates a sequence of operations that may be performed by the hardware and software environment of FIG. 3 to update a model that may be utilized to monitor service life for tires consistent with embodiments of the invention.

FIG. 8 is an example chart of temperature values for tires of a truck that may be received and analyzed by the hardware and software environment of FIG. 3.

FIG. 9 is an example chart of pressure values for tires of a truck that may be received and analyzed by the hardware and software environment of FIG. 3.

FIG. 10 is a flowchart that illustrates a sequence of operations that may be performed by the hardware and software environment of FIG. 3 to monitor a service life of a particular tire based on tire data consistent with embodiments of the invention.

FIG. 11 is a flowchart that illustrates a sequence of operations that may be performed by the hardware and software environment of FIG. 3 to extract features from collected data consistent with embodiments of the invention.

FIG. 12 is a flowchart that illustrates a sequence of operations that may be performed by the hardware and software environment of FIG. 3 to train a model for a tire based on one or more extracted features consistent with embodiments of the invention.

### DETAILED DESCRIPTION

Embodiments consistent with the invention monitor and analyze tire data for a tire to determine whether the tire is at or proximate an end of service life. In particular, tire data from a tire monitoring system for a particular tire of a vehicle may be received and analyzed according to a tire data model. Based on the tire data model, embodiments of the invention may determine whether the particular tire corresponds to an end of service life of the tire data model. In general, the tire data for the particular tire may include a plurality of data points that correspond to a collected data for the particular tire, including for example, pressure data, temperature data, location data (e.g., GPS data), and/or other such types of data that may be collected for a tire. In addition, at least with respect to temperature data, the temperature data may include temperature measurements specific to particular areas of a tire and/or wheel, as well as ambient temperature measurements. For example, temperature data may be collected for particular surface locations on a tire or wheel, as well as within the inner cavity of the tire. Such tire data may be referred to herein as tire pressure monitoring system (TPMS) data. In general, the tire data model may include modeled data based on tire data collected from one or more tires of one or more vehicles. The tire data model may include an end of service life that is modeled based at least in part on tire data collected for one or more tires of one or more vehicles.

In general, the modeled data of the tire data model may comprise modeled temperature values, pressure values, and/or other such values that may be modeled for a tire. The modeled data of the tire data model may comprise a data pattern that corresponds to an end of service life. For example, spikes in temperature values for a tire may be determined to correspond to an end of service life for the tire (e.g., where a tire disablement that makes the tire unusable may potentially occur). A tire data model consistent with embodiments of the invention may include an end of service life pattern determined to correspond tire temperatures for tires expected to be rendered unusable based upon a potential tire disablement according to the model in a relatively short period. For example, if an expected service life of a tire is 50,000 miles, a relatively short period may be 1,000 miles, 500 miles, 100 miles, etc. Similarly, if an expected service life of a tire is 5,000 hours of usage, a relatively short period may be 50 hours, 25 hours, 10 hours, 1 hour, etc. In general, an end of service life period may be selected to enable a tire to be replaced, repaired, or retreaded, as appropriate, prior to a potential tire disablement.

In general, a tire disablement related to a service life of the tire may incur significant costs to a fleet of vehicles, including downtime for a vehicle, etc. Embodiments of the invention may monitor a service life for each tire of each vehicle of a fleet, such that tires in an end of service life condition may be identified and replaced prior to the occurrence of a tire disablement or other such tire event. Therefore, consistent with embodiments of the invention, tire data collected for a particular tire may be analyzed with a tire data model to determine whether the particular tire is in an end of service life condition according to the tire data model, and a warning may be generated for the particular tire if the tire is determined to be in an end of service life condition. Other variations and modifications will be apparent to one of ordinary skill in the art.

### Hardware and Software Environment

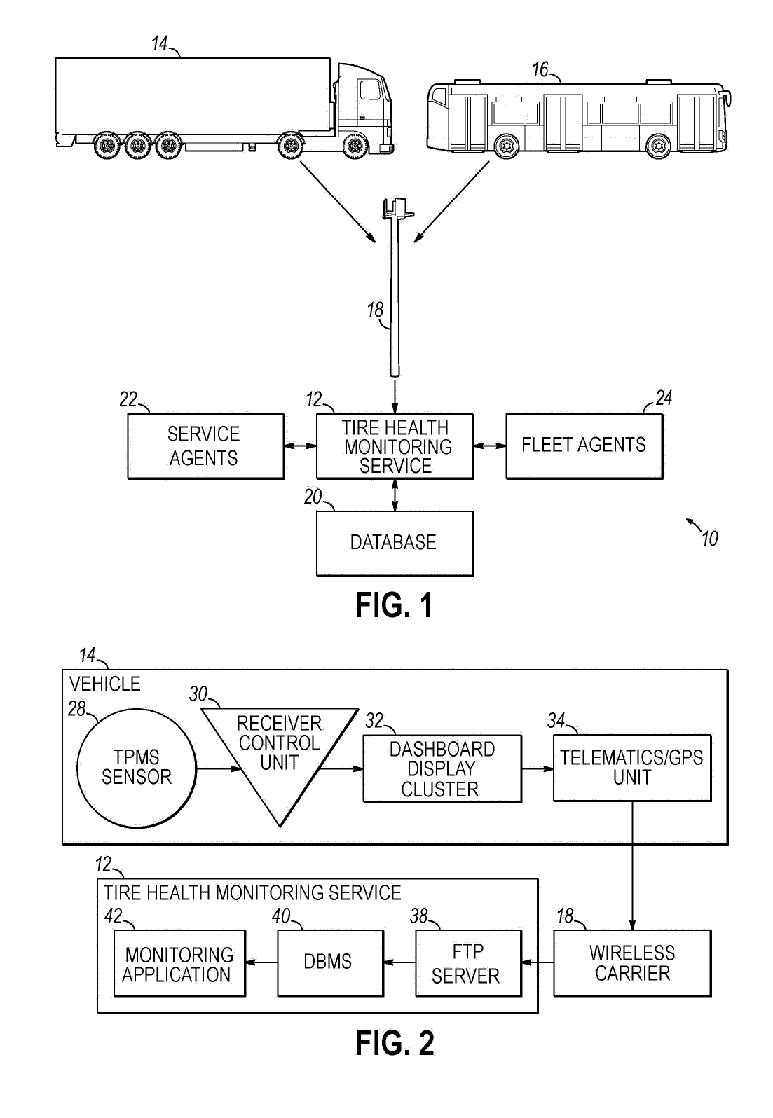

Turning now to the drawings, wherein like numbers denote like parts throughout the several views, FIG. 1 illustrates an exemplary tire health monitoring system 10 implemented as a tire health monitoring service 12 capable of monitoring a plurality of vehicles, e.g., a tractor trailer 14 and a bus 16. It will be appreciated that service 12 may be capable of monitoring the tires of practically any type of vehicle, including, for example, passenger vehicles, cars, trucks, vans, construction equipment, agricultural equipment, buses, etc., so the invention is not limited to the particular vehicles illustrated in FIG. 1.

Service 12 wirelessly communicates with vehicles 14, 16 via a network 18, e.g., via a wireless carrier, which may be operated by the same entity that operates service 12, or by a separate entity altogether, and may be public, private or proprietary in nature. Service 12 may be coupled to network 18 by wired and/or wireless communication media.

Service 12 is coupled to a database 20 that is used to store tire pressure monitoring system (TPMS) data retrieved from vehicles 14, 16, e.g., pressure, temperature, a vehicle identifier, a tire identifier, a wheel identifier, location data (e.g., GPS data), odometer information, and/or a timestamp. Moreover, as will be discussed in greater detail below, service 12 may be accessed by various entities, including, for example, service agents 22 that are either agents of the provider of service 12 or authorized representatives thereof, e.g., authorized dealers and/or service centers. Moreover, in some embodiments that monitor on behalf of fleets of vehicles, fleet agents 24 may also be provided with access to service 12. Additional interfaces, e.g., for vehicle operators or owners, administrators, etc., may also be provided in some embodiments of the invention.

FIG. 2 illustrates in greater detail the components in system 10 used to retrieve, communicate and process TPMS data. For example, on vehicle 14, a plurality of TPMS sensors 28 may be installed on each tire/wheel of the vehicle, and configured to communicate TPMS data to a receiver control unit (RCU) 30 disposed on the vehicle. The typical locations of these components are illustrated graphically by corresponding circles and inverted triangles in FIG. 2, and it will be appreciated that multiple RCU's 30 may be disposed in different locations on a vehicle in order to communicate with proximate TPMS sensors 28.

Each RCU 30 typically outputs the TPMS data to a dashboard display cluster 32 on vehicle 14, which may perform some processing of the TPMS data and may report such data to an operator, e.g., pressure readings, temperature readings, and/or low pressure and/or temperature alerts. Cluster 32 may be a programmable electronic or computer device incorporating audio and/or visual indicators or displays, and may be integrated with other on-board electronic components. In some embodiments, e.g., where no central monitoring service is used, the monitoring functionality as disclosed herein may be performed locally in vehicle 14, e.g., within cluster 32 or another on-board electronic component.

In the illustrated embodiment that does incorporate central monitoring, vehicle 14 also includes a telematics/GPS unit 34 that communicates with wireless carrier 18 to communicate TPMS data to service 12. Unit 34 may be configured to output location data generated by an integrated GPS receiver as well as additional data collected by sensors 28. It will be appreciated that the data communicated by unit 34 may be pre-processed in some embodiments or may be raw data. Furthermore, the protocol by which data is communicated to wireless carrier 18 may vary in different embodiments. Furthermore, in some embodiments, GPS sensing may be omitted. In addition, in some embodiments, bi-directional communication may be supported such that, for example, service 12 may provide the operator of vehicle 14 with alerts or status information, and may provide a mechanism by which an operator may be put into communication with a service agent, e.g., via electronic message, voice and/or video communications to address any alert conditions or coordinate service of the vehicle.

Wireless carrier 18 provides TPMS and other data provided by unit 34 to service 12, e.g., by interfacing with an FTP server 38. Server 38 passes the incoming data to a database management system 40 to log the incoming data in database 20. This data is then monitored and processed by a monitoring application 42, in the manner discussed in greater detail below.

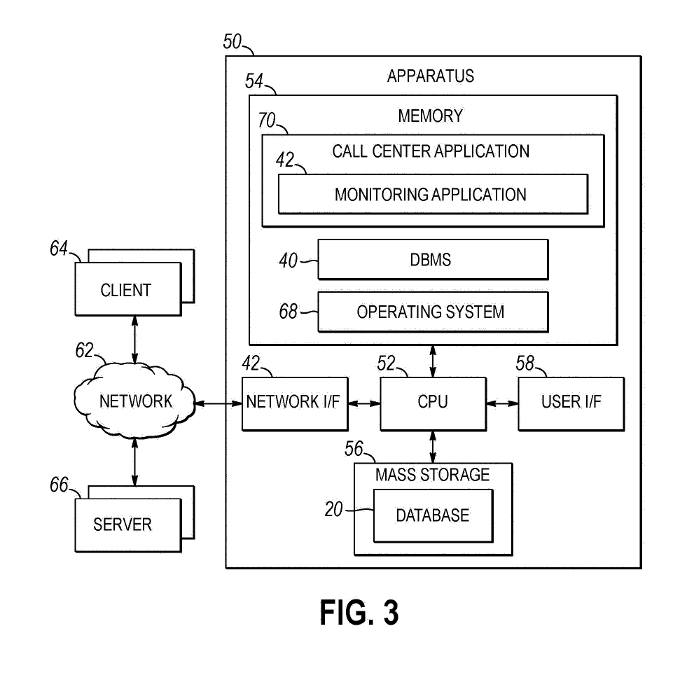

Now turning to FIG. 3, an exemplary hardware and software implementation of service 12, within an apparatus 50, is illustrated. For the purposes of the invention, apparatus 50 may represent practically any type of computer, computer system or other programmable electronic device, and will be referred to hereinafter as a computer for simplicity. It will be appreciated, however, that apparatus 50 may be implemented using one or more networked computers, e.g., in a cluster or other distributed computing system, or may be implemented within a single computer or other programmable electronic device, e.g., a desktop computer, laptop computer, handheld computer, cell phone, set top box, etc.

Computer 50 typically includes a central processing unit 52 including at least one microprocessor coupled to a memory 54, which may represent the random access memory (RAM) devices comprising the main storage of computer 50, as well as any supplemental levels of memory, e.g., cache memories, non-volatile or backup memories (e.g., programmable or flash memories), read-only memories, etc. In addition, memory 54 may be considered to include memory storage physically located elsewhere in computer 50, e.g., any cache memory in a processor in CPU 52, as well as any storage capacity used as a virtual memory, e.g., as stored on a mass storage device 56 or on another computer coupled to computer 50. Computer 50 also typically receives a number of inputs and outputs for communicating information externally. For interface with a user or operator, computer 50 typically includes a user interface 58 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 50 may also include one or more mass storage devices 56, e.g., a floppy or other removable disk drive, a hard disk drive, a direct access storage device (DASD), an optical drive (e.g., a CD drive, a DVD drive, etc.), and/or a tape drive, among others. Furthermore, computer 50 may include an interface 60 with one or more networks 62 (e.g., a LAN, a WAN, a wireless network, and/or the Internet, among others) to permit the communication of information with other computers and electronic devices, e.g., one or more client computers 64 (e.g., for interfacing with agents 22, 24) and one or more servers 66 (e.g., implementing other aspects of service 12). It should be appreciated that computer 50 typically includes suitable analog and/or digital interfaces between CPU 52 and each of components 54, 56, 58 and 60 as is well known in the art. Other hardware environments are contemplated within the context of the invention.

Computer 50 operates under the control of an operating system 68 and executes or otherwise relies upon various computer software applications, components, programs, objects, modules, data structures, etc., e.g., a call center application 70 (within which, for example, monitoring application 42 may be implemented). Moreover, various applications, components, programs, objects, modules, etc. may also execute on one or more processors in another computer coupled to computer 50 via network 62, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium that can be used to store the desired information and which can be accessed by computer 50. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIGS. 1-3 is not intended to limit the present invention. Indeed, those skilled in the art will recognize that other alternative hardware and/or software environments may be used without departing from the scope of the invention.

### Tire Service Life Monitoring

Embodiments consistent with the invention analyze tire data of a tire of a vehicle to determine whether the tire is in an end of service life condition. In general, end of service life condition of a tire corresponds to a condition of the tire that precedes a potential tire disablement that renders the tire unusable. Embodiments of the invention are configured to analyze tire data collected for a particular tire to determine whether a service life of the particular tire corresponds to an end of service life of a tire data model. In general, the end of service life of the tire data model includes modeled data based on tire data collected from one or more tires that were determined to be in end of service life condition. For example, the modeled data of the end of service life of the tire data model may be based on tire data for one or more tires that experienced tire disablements within a defined time/usage period following collection of the data. Therefore, a tire data model consistent with embodiments of the invention may generally be based on collected tire data.

Furthermore, in some embodiments of the invention, a tire data model may be updated responsive to receiving tire data from one or more tires, such that the tire data model may be “trained” based on the received tire data. Therefore, in these embodiments the tire data model may be improved with regard to identifying tires that are in an end of service life condition as the tire data model is trained and retrained with collected tire data. In general, while description describes analyzing TPMS data for a particular tire, the invention is not so limited. As will be appreciated, in some embodiments of the invention TPMS data may be received for each tire of a vehicle, and the service life of each tire of the vehicle may be monitored as described herein concurrently.

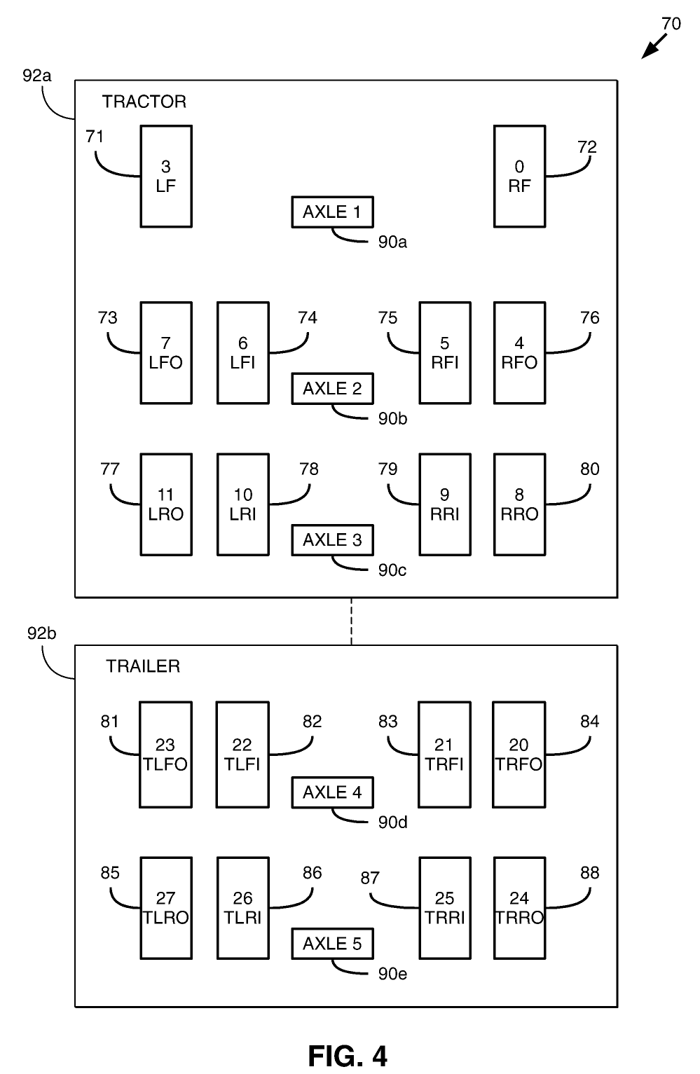

Referring to FIG. 4, this figure provides a block diagram that illustrates an example tire layout 70 for a tractor-trailer type vehicle. As shown, this example vehicle is configured with 18 wheels 71-88 (and therefore 18 tires) configured on five axles, which are labeled ‘AXLE 1’ 90a, ‘AXLE 2’ 90b, ‘AXLE 3’ 90c, ‘AXLE 4’ 90d, and ‘AXLE 5’ 90e. Furthermore, as illustrated, the wheels 71-88 may be generally grouped into a tractor group 92a (wheels 71-80) and a trailer group 92b. In this example, each wheel 71-88 is further labeled with a wheel identifying number as well as a positional descriptor.

As shown, the vehicle generally includes: a right front (‘RF’, 0) wheel 72 and a left front (‘LF’, 3) wheel on the first axle 90a (also referred to as “steer” wheels/tires); a right front outer (‘RFO’, 4) wheel 76, a right front inner (‘RFI’, 5) wheel 75, a left front inner (‘LFI’, 6) wheel 74, and a left front outer (‘LFI’, 7) wheel 73 on the second axle 90b (also referred to as “drive” wheels/tires); a right rear outer (‘RRO’, 8) wheel 80, a right rear inner (‘RRI’, 9) wheel 79, a left rear inner (‘LRI’, 10) wheel 78, and a left rear outer (‘LRO’, 11) wheel 77 on the third axle 90c (also referred to as “drive” wheels/tires); a trailer right front outer (‘TRFO’, 20) wheel 84, a trailer right front inner (‘TRFI’, 21) wheel 83, a trailer left front inner (‘TLFI’, 22) wheel 82, and a trailer left front outer (‘TLFO’, 23) wheel 81 on the fourth axle 90d; and a trailer right rear outer (‘TRRO’, 24) wheel 88, a trailer right rear inner (‘TRRI’, 25) wheel 87, a trailer left rear inner (‘TLRI’, 26) wheel 86, and a trailer left rear outer (‘TLRO’, 27) wheel 85 on the fifth axle 90e.

As is generally understood, each wheel 71-88 is generally configured with a corresponding tire. Consistent with embodiments of the invention, TPMS data may be collected for each tire of each wheel. Moreover, each tire may be referred to with relation to the positional descriptor (i.e., RF, LF, RFO, RFI, etc.) and/or the wheel identifying number. Embodiments of the invention generally may be utilized to monitor service life for tires for of a variety of types of vehicles, and the example tire layout 70 is therefore intended to be non-limiting and provided for illustrative purposes.

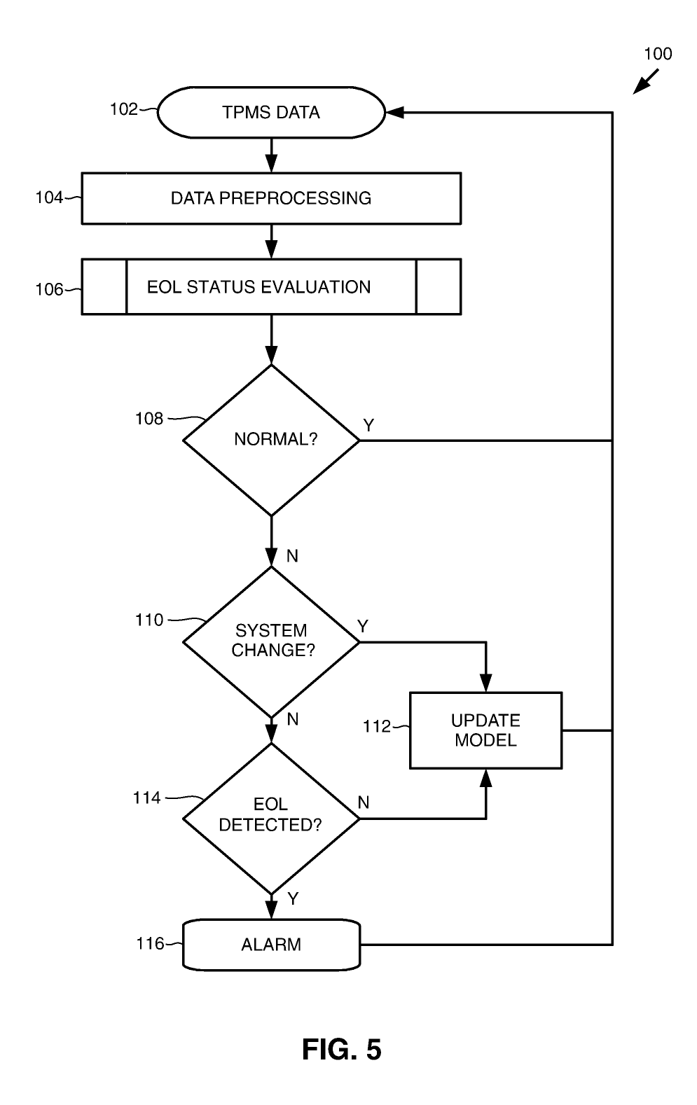

Turning now to FIG. 5, this figure provides a flowchart 100 that illustrates a sequence of operations that may be performed by a computer consistent with embodiments of the invention to monitor a service life of a particular tire based on tire data (e.g., TPMS data) (block 102) received for the particular tire. The TPMS data may be preprocessed (block 104). In general, the TPMS data may be preprocessed to remove impossible combination outliers and/or out of range outliers. Data preprocessing may include filtering raw data, determining average values for temperature and/or pressure values of the TPMS data, and/or removing data points that are outliers. For example, an average temperature/pressure value for hourly, daily, and/or other such periods may be determined based on the TPMS data. The preprocessed data may be evaluated based at least in part on a tire data model (block 106). In some embodiments, the tire data model may be based at least in part on TPMS data for one or more tires. In some embodiments, the tire data model may be based at least in part on a modeled temperature profile that is associated with an end of service life condition.

As will be understood, embodiments of the invention may receive TPMS data associated with a plurality of tires for one or more vehicles, and in some embodiments, the tire data model may be based on TPMS data received for the plurality of tires for the one or more vehicles. Consistent with some embodiments, the tire data model may be based at least in part on previously collected tire data (e.g., historical tire data) associated with the vehicle of the particular tire, such that the tire data model accounts for an initial condition of the particular tire, and not just the current status. In some embodiments, the tire data model may be based at least in part on tire data for similar tires of the particular tire (e.g., same model of tire, same position on the vehicle or similar vehicles, same region of usage, etc.). In summary, the tire data model may be based at least in part on tire data, such as TPMS data, associated with various tires of various vehicles that through training of the tire data model are determined to be relevant for monitoring a service life of the particular tire.

Based on the evaluation, the computer determines whether the status for the particular tire is normal according to the model (block 108). In general, the tire data model may define modeled values corresponding to an end of service life condition for a tire and/or modeled values corresponding to a properly operating tire. For example, the tire data model may include modeled temperature values corresponding to an end of service life (i.e., not a normal status) and/or modeled temperature values corresponding to a normal tire. Furthermore, consistent with embodiments of the invention, the tire data model may be utilized to perform pattern recognition to determine whether the particular tire is normal. In response to determining that the status of the particular tire is normal (“Y” branch of block 108), the computer continues processing TPMS data to monitor the service life of the particular tire.

In response to determining that the status of the particular tire is not normal according to the model (“N” branch of block 108), the computer detects whether any deliberate change to the vehicle has affected the collected TMPS data and possibly the evaluation of the temperature data with the model (block 110). A deliberate change, for example, may be an alignment correction, a tire change, a tire inflation, and/or other such types of changes that may cause the collected TMPS data to change in manner not expected by the model. Consistent with embodiments of the invention, the computer may detect a system change to the vehicle by analyzing maintenance data associated with the vehicle, by receiving input from a user that indicates a system change, and/or the model may perform system change detection, where such system change detection may analyze the TPMS data to detect TPMS data that according to the model corresponds to a system change. In response to detecting a system change (“Y” branch of block 110), the computer updates the model with the TPMS data and information associated with the system change (block 112) such that the model is retrained based on the evaluated TPMS data associated with the system change. After updating the model, the computer may continue monitoring and analyzing TPMS data for the particular tire to monitor the service life of the tire.

In response to determining that a system change did not occur (“N” branch of block 110), the computer determines whether the TPMS data indicates that the tire is in end of service life (EOL) condition according to the tire data model (block 114). In general, the model may include a pattern of data associated with an end of service life condition, including for example, patterns of temperature values modeled on temperature data collected for tires determined to be in end of service life condition. In response to determining that the particular tire is not in end of service life condition (“N” branch of block 114), the computer updates the model (block 112), such that one or more models are retrained according to the evaluated TPMS data that was determined to not correspond to a tire in an end of service life condition. In general, the tire data model may be trained with TPMS data of tires determined to be in end of service life condition (such as by a maintenance inspection) and/or tires that experience an end of service life event. After updating the model, the computer may continue monitoring and analyzing TPMS data for the particular tire to thereby monitor the service life of the tire. In response to determining that the particular tire is in an end of service life condition (“Y” branch of block 114), the computer generates an alarm indicating that the particular tire has been determined to be in an end of service life condition according to the tire data model (block 116). Consistent with some embodiments of the invention, the alarm may indicate the information about the particular tire and/or vehicle (e.g., tire identifier, vehicle identifier, etc.).

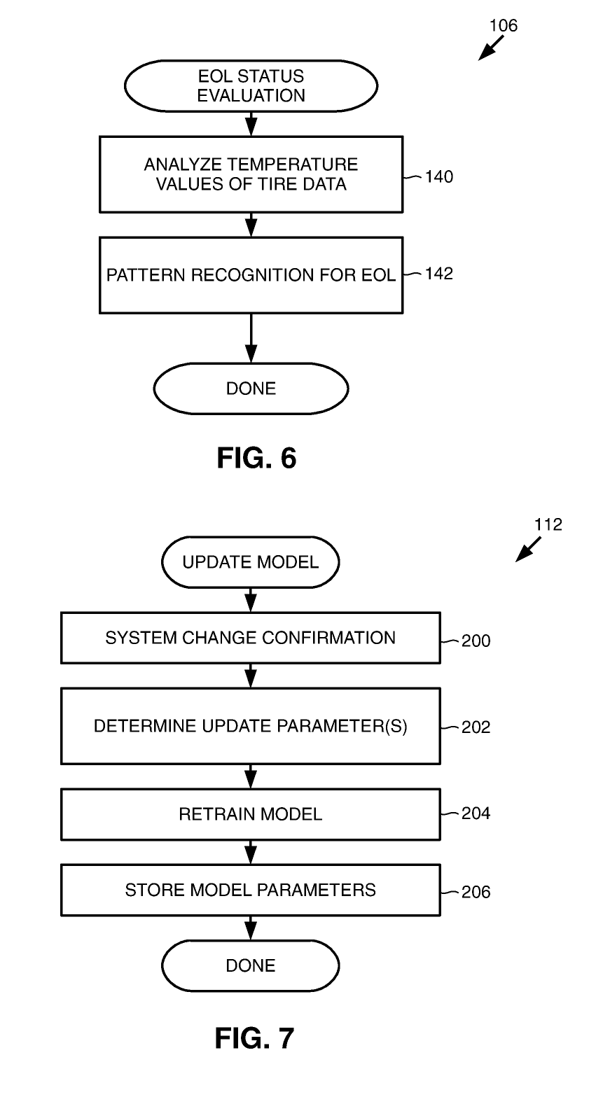

Turning now to FIG. 6, this figure provides a flowchart 106 that illustrates a sequence of operations that may be performed by a computer consistent with embodiments of the invention to evaluate TPMS data for a particular tire of a vehicle as shown in block 106 of FIG. 5. Consistent with embodiments of the invention, the computer may analyze temperature data of the TPMS data with a temperature model developed based on temperature data for one or more tires. Moreover, in some embodiments, TPMS data for a particular tire of a particular vehicle may be analyzed based on a model that is based on historical temperature data for the tires at the same location on the particular vehicle. As shown in FIG. 6, temperature values of the TPMS data for the particular tire may be analyzed (block 140), and pattern recognition based on a modeled end of service life of the tire data model may be performed to determine whether the particular is normal or in an end of service life condition (block 142). For example, in some embodiments of the invention, the temperature values for the particular data may be analyzed to recognize abnormal temperature value spikes as corresponding to a tire in an end of service life condition.

FIG. 7 provides a flowchart 112 that illustrates a sequence of operations that may be performed by a computer consistent with embodiments of the invention to update a model that is maintained to evaluate a service life of a particular tire. As discussed previously, a system change for the vehicle may lead to the TPMS data from the particular tire being determined to be non-normal status. Therefore, some embodiments of the invention may confirm a system change notification (block 200) if applicable. For example, after a system change, a maintenance technician may confirm a system change for a vehicle, which may be stored in a record associated with the vehicle in a database. In this example, the computer may analyze the record associated with the vehicle to confirm the system change.

The computer may determine update parameters for the model (block 202). As shown in FIG. 5, the model may be updated responsive to detecting a system change and/or determining that the particular tire is not in end of service life condition. Consistent with embodiments of the invention, the model may be updated with information corresponding to TPMS data of the particular tire. Therefore, the computer may determine one or more parameters to be updated based on the analyzed temperature data. Using such determined update parameters, the model may be retrained (block 204). Therefore, if analysis of TPMS data according to the model results in determining that the particular tire does not have a normal status but also is not in an end of service life condition, the model may be retrained based on the TPMS data. After retraining the model, model parameters associated with the vehicle are stored with the model (block 206).

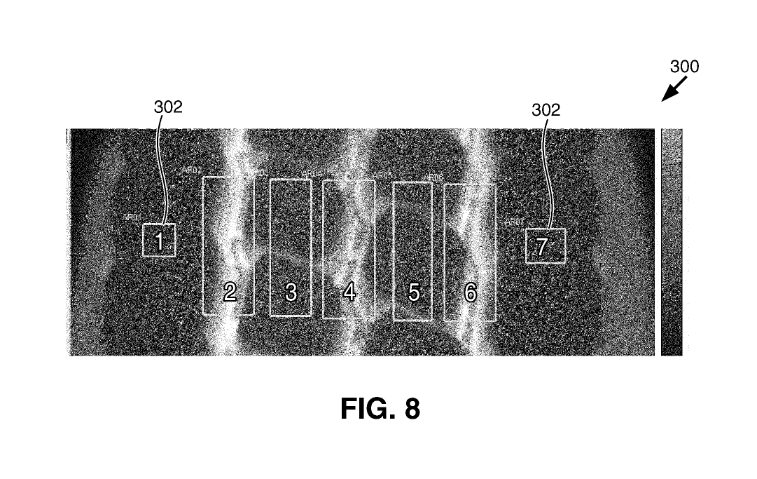

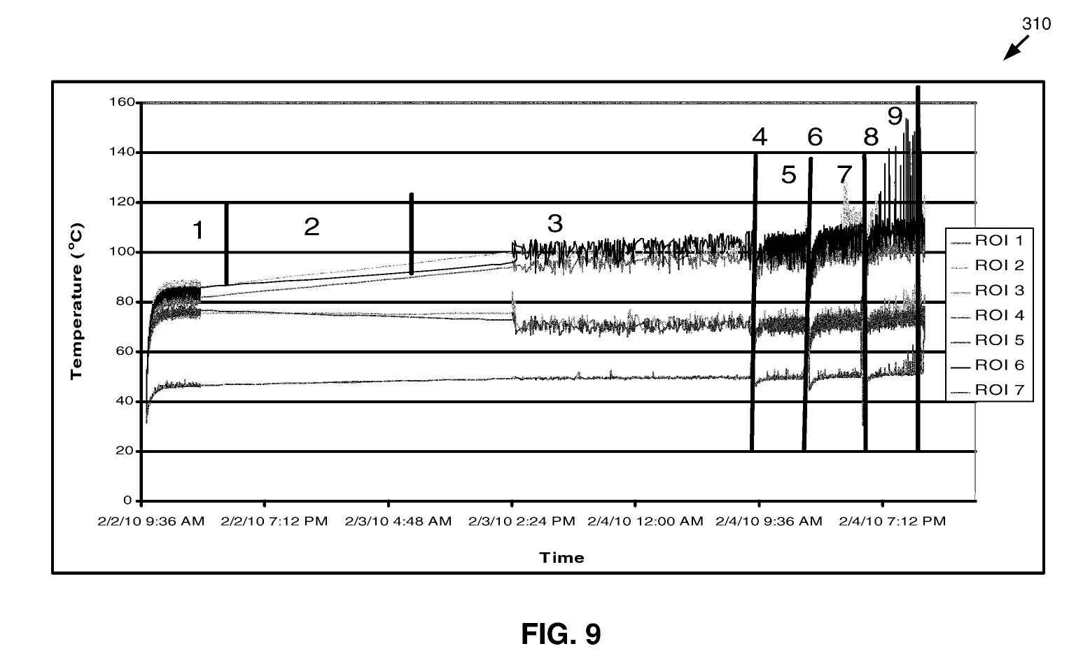

Turning now to FIG. 8, this figure provides an example diagram of a tire surface 300 that includes a plurality of regions of interest 302 (labeled 1 to 7) on the surface of the tire. FIG. 9 provides an example chart 310 that illustrates collected temperature data for the regions of interest 302 of FIG. 8 during an example durability test. As illustrated in the example, temperature values may spike when the tire approaches an end of service life condition.

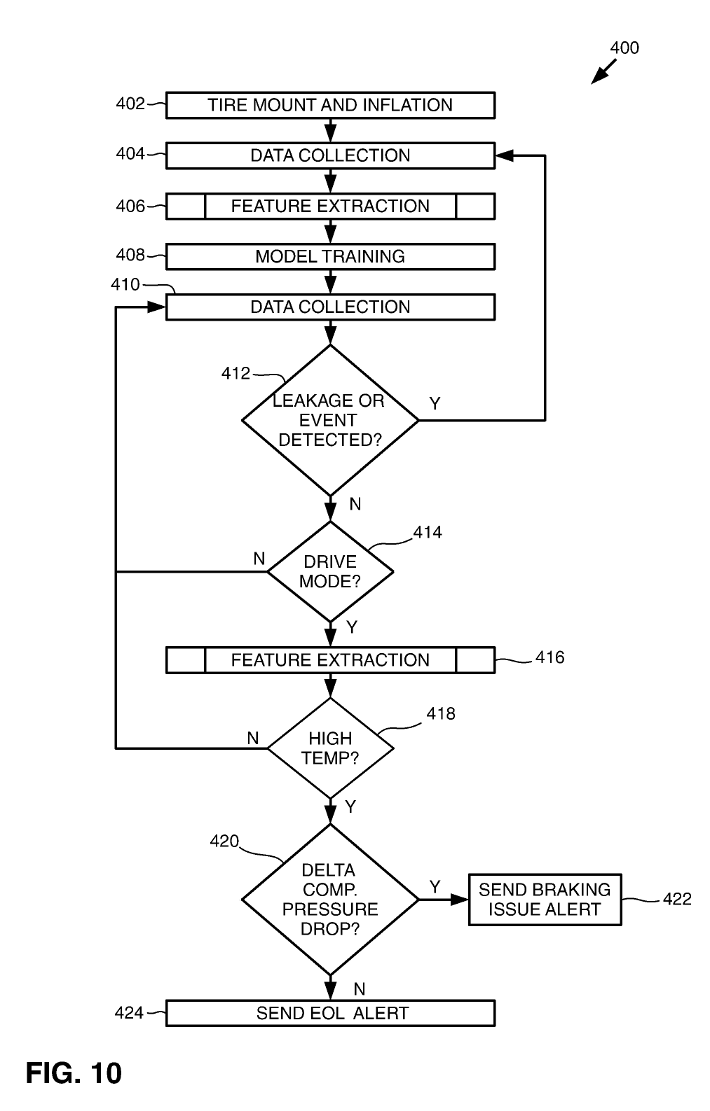

Turning now to FIG. 10, this figure provides a flowchart 400 that illustrates a sequence of operations that may be performed by a computer consistent with embodiments of the invention to monitor a service life of a particular tire based on tire data (e.g., TPMS data). As shown, a tire may be mounted on a vehicle and inflated (block 402). After mounting and inflation, data for the tire (e.g., TPMS data) may be collected (block 404). One or more features may be extracted from the collected data for the tire (block 406). In general, such features may include a temperature change, a pressure change, and/or other such characteristics of the tire. Moreover, in some embodiments the features may be normalized based at least in part on another feature. For example, pressure values may be compensated based at least in part on temperature values. A model associated with the tire may be trained based at least in part on extracted features (block 408), and data collection may continue (block 410).

In general, tire leakage or a system change event (e.g., tire rotation/balancing), etc. may cause a change in collected data that may be incorrectly identified as the tire nearing an end of service life condition. Therefore, consistent with embodiments of the invention, the computer may monitor the collected data to detect pressure leakage or a system change event (block 412). If leakage or a system change event is detected (“Y” branch of block 412), the computer may collect data (block 404), extract one or more features from the data (block 406), and train the model (block 408) with the extracted features. If leakage or a system change event is not detected (“N” branch of block 412), the computer may determine if the vehicle has been driven during data collection (block 414). In general, data collected from tires of a parked vehicle may also be incorrectly identified as the tire nearing an end of service life condition. Therefore, embodiments of the invention may determine whether the vehicle was in operation (i.e., drive mode) during data collection by analyzing odometer data and/or GPS data of the collected data. If the vehicle was not in drive mode (“N” branch of block 412), the computer may continue to collect data (block 410) and process the data.

If the vehicle was determined to be in drive mode (“Y” branch of block 414), one or more features may be extracted from the collected data (block 416). The computer may analyze the one or more extracted features to determine if the collected data indicates a high temperature according to the model developed for the tire (block 418). If the one or more extracted features do not indicate a high temperature according to the model (“N” branch of block 418), data may continue to be collected (block 410) and processed (blocks 412 to 418). In response to the one or more extracted features indicating a high temperature for the tire according to the model (“Y” branch of block 418), the computer determines whether the one or more extracted features indicate that a temperature compensated pressure difference (i.e., delta pressure) exists between the tire and one or more other tires (block 420). In response to determining that a temperature compensated pressure difference exists (“Y” branch of block 420), the computer may communicate a braking issue alert (block 422). In response to determining that a temperature compensated pressure difference does not exist (“N” branch of block 420), the computer may communicate a tire end of service life condition alert (block 424).

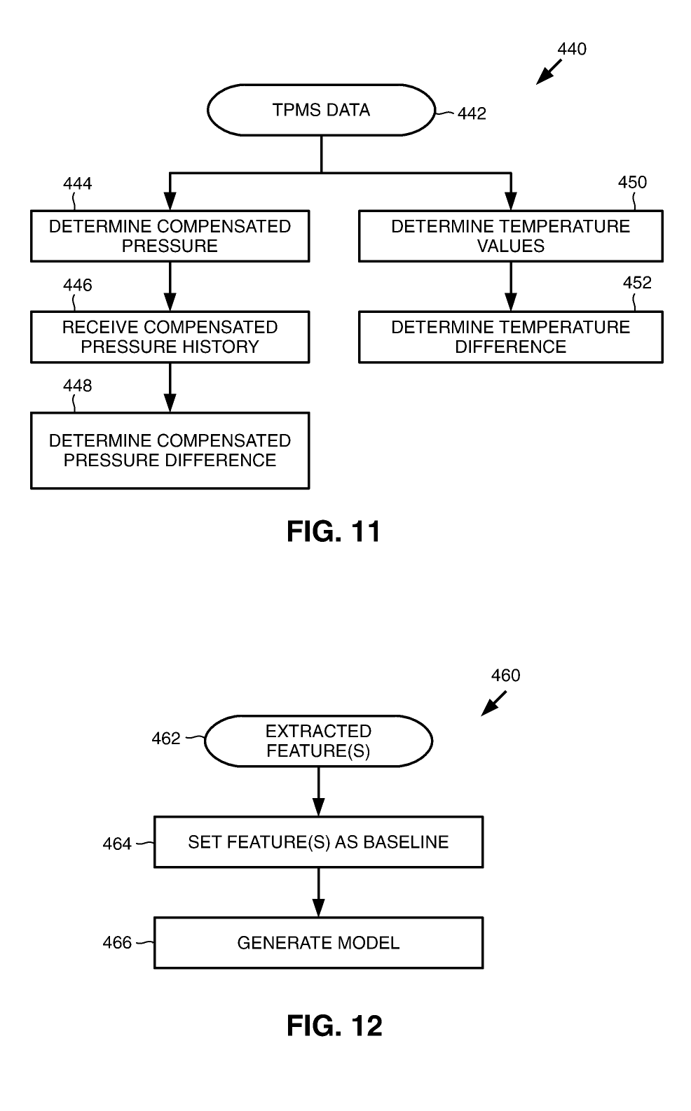

FIG. 11 provides a flowchart 440 that illustrates a sequence of operations that may be performed by a computer consistent with embodiments of the invention to extract features from collected data (e.g., TPMS data block 442) for a particular tire. The computer determines a compensated pressure value (block 444). The computer may receive one or more compensated pressure values for one or more tires of the vehicle (i.e., compensated pressure history) (block 446), and the computer may determine a compensated pressure difference between the particular tire and one or more other tires (block 448). In addition, the computer may determine temperature values for the particular tire and at least one other tire of the vehicle (block 450), and the computer may determine a temperature difference between the particular tire and the at least one other tire of the vehicle (block 452).

FIG. 12 provides a flowchart 460 that illustrates a sequence of operations that may be performed by a computer consistent with embodiments of the invention to train a model for a tire based at least in part on one or more extracted features (block 462). The computer may set the extracted features as a baseline for the model (block 464), and the computer may generate the model for the tire (block 466). In general, the extracted features set as the baseline will correspond to data collected immediately after mounting and inflation of the tire.

Furthermore, as should be appreciated, consistent with some embodiments of the invention, the tire data model may be based at least in part on temperature and pressure data associated with one or more tires. In such embodiments, an end of service life of a particular tire may be evaluated based at least in part on temperature and pressure values associated with the particular tire. Moreover, pattern recognition performed according to the model may analyze pressure values and temperature values of the particular tire to determine whether the particular tire is in an end of service life condition. In addition, the tire data model may be based at least in part on additional types of data, such as location data, odometer data, and/or other types of TPMS data. Consistent with embodiments of the invention, tire data may be preprocessed to refine data prior to evaluation. Such preprocessing, as described above, may include filtering, averaging, etc., as well as deriving values for evaluation based at least in part on one or more different types of data. For example, temperature values evaluated for a tire may be pressure compensated. As another example, temperature/pressure values may be filtered based on odometer data, such that only temperature values collected when the vehicle was in use (i.e., not parked) are evaluated. As another example, a temperature value evaluated for a tire may be a calculated temperature variance between a particular tire and a related tire on the vehicle and/or a similar tire, where such relations/similarities may be user defined.

It will be appreciated that the determination of a mean or median using a subset of tires from a vehicle may be implemented in various manners consistent with the invention, and may include various numbers and combinations of tires from a vehicle. For example, a mean or median may be taken from each axle, from each tire type (e.g., steer/drive/trailer), or from steer, inner drive, outer drive, inner trailer and/or outer trailer tires. Alternatively, a mean or median may be taken from the maximum and minimum, or the second maximum and second minimum from any of the aforementioned tire combinations. The invention, however, is not limited to the particular determinations disclosed herein.

It will also be appreciated that while the illustrated embodiments utilize tire data such as pressure, temperature and timestamps, additional data, such as ambient temperature, tread depth, additional temperatures taken at different points on a tire, rim or wheel, vibration, etc. may also be used in a tire monitoring system consistent with the invention. Therefore, the invention is not limited to the particular embodiments discussed herein.

Various additional modifications may be made without departing from the spirit and scope of the invention. Therefore, the invention lies in the claims hereinafter appended.

What is claimed is:

1. A method for monitoring service life of a tire, the method comprising:
receiving tire data from a tire monitoring system for a particular tire of a vehicle;
analyzing the tire data with a tire data model to determine whether a service life of the particular tire corresponds to an end of service life of the tire data model; and
in response to determining that the service life of the particular tire corresponds to the end of service life of the tire data model, generating an alarm for the particular tire.

2. The method of claim 1, wherein the tire data includes temperature data and pressure data for the particular tire.

3. The method of claim 1, wherein analyzing the tire data with a tire data model to determine whether a service life of the particular tire corresponds to an end of service life of the tire data model comprises:
analyzing a plurality of data points of the tire data to determine whether the data points of the tire data correspond to the tire data model.

4. The method of claim 3, wherein analyzing the plurality of data points of the tire data to determine whether the data points of the tire data correspond to the data point model of the tire data model comprises:
comparing a pattern formed by the data points of the tire data to a modeled data pattern of the tire data model.

5. The method of claim 3, wherein each of the plurality of data points correspond to a temperature value for the particular tire, and analyzing the plurality of data points of the tire data to determine whether the data points of the tire data correspond to the tire data model comprises:
determining whether the temperature values of the plurality of data points correspond to an abnormal temperature spike model included in the tire data model.

6. The method of claim 3, wherein each of the plurality of data points correspond to a pressure value for the particular tire, and analyzing the plurality of data points of the tire data to determine whether the data points of the tire data correspond to the tire data model comprises:
determining whether the pressure values of the plurality of data points correspond to an abnormal pressure spike model included in the tire data model.

7. The method of claim 1, further comprising:
determining whether a system change occurred for the vehicle that corresponds to the particular tire, wherein generating the alarm is responsive to determining that a system change did not occur for the vehicle that corresponds to the particular tire.

8. The method of claim 7, further comprising:
updating the tire data model responsive to determining that a system change occurred for the vehicle that corresponds to the particular tire.

9. The method of claim 1, further comprising:
filtering the tire data based at least in part on odometer data.

10. The method of claim 1, wherein the tire data model corresponds to the vehicle and is based at least in part on historical tire data collected for the vehicle.

11. The method of claim 1, wherein the end of service life of the tire data model corresponds to a defined time period that precedes an expected tire disablement for which the tire data model is configured to model.

12. An apparatus, comprising:
at least one processor; and
program code configured upon execution by the at least one processor to cause the at least one processor to receive tire data from a tire monitoring system for a particular tire of a vehicle, analyze the tire data with a tire data model to determine whether a service life of the particular tire corresponds to an end of service life of the tire data model, and responsive to determining that the service life of the particular tire corresponds to the end of service life of the tire data model, generate an alarm for the particular tire.

13. The apparatus of claim 12, wherein the tire data includes temperature data and pressure data for the particular tire.

14. The apparatus of claim 12, wherein the program code is configured to analyze the tire data with a tire data model to determine whether a service life of the particular tire corresponds to an end of service life of the tire data model by:
analyzing a plurality of data points of the tire data to determine whether the data points of the tire data correspond to the tire data model.

15. The apparatus of claim 14, wherein the program code is configured to analyze the plurality of data points of the tire data to determine whether the data points of the tire data correspond to the data point model of the tire data model by:
comparing a pattern formed by the data points of the tire data to a modeled data pattern of the tire data model.

16. The apparatus of claim 14, wherein each of the plurality of data points correspond to a temperature value for the particular tire, and the program is configured to analyze the plurality of data points of the tire data to determine whether the data points of the tire data correspond to the tire data model by:
determining whether the temperature values of the plurality of data points correspond to a temperature spike model included in the tire data model.

17. The apparatus of claim 12, wherein the program code is further configured upon execution to cause the at least one processor to determine whether a system change occurred for the vehicle that corresponds to the particular tire, wherein generating the alarm is responsive to determining that a system change did not occur for the vehicle that corresponds to the particular tire.

18. The apparatus of claim 17, wherein the program code is further configured upon execution to cause the at least one processor to update the tire data model responsive to determining that a system change occurred for the vehicle that corresponds to the particular tire.

19. The apparatus of claim 12, wherein the program code is further configured upon execution to cause the at least one processor to filter the tire data based at least in part on odometer data.

20. A program product, comprising:
a non-transitory computer readable medium; and
program code stored on the computer readable medium and configured upon execution by at least one processor to cause the at least one processor to receive tire data from a tire monitoring system for a particular tire of a vehicle, analyze the tire data with a tire data model to determine whether a service life of the particular tire corresponds to an end of service life of the tire data model, and responsive to determining that the service life of the particular tire corresponds to the end of service life of the tire data model, generate an alarm for the particular tire.
